(19) United States
(12) Patent Application Publication
(10) Pub. No.: US 2010/0264125 A1
(43) Pub. Date: Oct. 21, 2010

(54) WELDING LOWER ELECTRODE DEVICE

(75) Inventor: Masato HIDAKA, Kanagawa (JP)

Correspondence Address: LEE FREDRIC SHARRA, 4313 TROUTHAVEN DRIVE, MURRYSVILLE, PA, 15668, US

(73) Assignee: SMK CO., LTD., Kanagawa (JP)

(21) Appl. No.: 12/762,301

(22) Filed: Apr. 16, 2010

(30) Foreign Application Priority Data
Apr. 17, 2009 (JP) 2009-101303

(51) Int. Cl. B23K 9/28; B23K 9/00

(52) U.S. Cl. 219/136; 219/138

(57) ABSTRACT

An object of the present invention is to reduce the size of an entire device by simplifying a device configuration, and also accurately measure the stroke position of a rod. A lower electrode 2 is mounted on an upper portion of an electrode holder tube 3. A rod 4 that is vertically movable within the electrode holder tube 3 is divided into a first rod 4a and a second rod 4b. The rod 4 is urged upward by a compressed spring 5 that is interposed between a spring receiving seat 14 fixed to the upper end surface of the second rod 4b and an insulating adapter 7. Pressurized air supplied from a pressurized air supply pipe 15 to assist the urging force is received by a pressure receiving portion on the lower surface of the spring receiving seat 14, thereby assisting the spring 5 to urge the rod 4 upward. A magnetic sensor 10 is disposed below the second rod 4b, and a lower end portion of the second rod 4b is directly connected to a detector 17 of the magnetic sensor 10.

### BACKGROUND OF THE INVENTION

1. Field of the Invention

The present invention relates to a welding lower electrode device having a simple configuration and used in combination with an upper electrode device when a nut, a bolt or the like is welded to a plate-like workpiece, for example.

2. Description of the Related Art

As a lower electrode device used in combination with an upper electrode device to weld a nut or the like to a plate-like workpiece, a technique as described below has been conventionally known. In the technique, while a positioning pin is disposed on an upper portion of a rod that is vertically movable and is urged upward within an electrode holder tube, a plate-like workpiece and a nut or the like each having a hole therein are placed on a lower electrode, and the positioning pin projects upward through the holes. The plate-like workpiece and the nut or the like are brought into close contact with each other by lowering an upper electrode and thereby pressing the nut, and the top and bottom stroke positions of the rod at this point are detected, thereby detecting a trouble in welding, a failure in a welding state, or the like. As the means for urging the rod upward, an air cylinder unit for driving a piston in a cylinder is often used (for example, see Japanese Patent Laid-Open Nos. 07-100660 and 09-295162).

Meanwhile, a technique of urging only a positioning pin upward and detecting malfunction of a nut or the like in welding has been also known (for example, see Japanese Patent Laid-Open No. 09-10956). In the technique, a spring is loaded within a lower electrode, and only the positioning pin is urged upward by the spring.

However, the technique as described above has a problem that the device becomes larger and also increases in manufacturing cost when a device such as the air cylinder unit is employed as the means for urging the rod upward. Meanwhile, when the rod and the positioning pin are urged by the spring or the like, the device is manufactured at a low cost. However, a large load is applied to the spring since the rod and the positioning pin repeat an up-and-down stroke. Spring characteristics thereby vary, and an error occurs in detection of the stroke position, thereby causing a problem that stroke determination cannot be accurately performed.

Accordingly, it is an object of the present invention to reduce the size of an entire device by simplifying a device configuration, and also accurately measure the stroke position of a rod.

### SUMMARY OF THE INVENTION

In order to achieve the above object, the present invention provides a welding lower electrode device including: a rod disposed within an electrode holder tube and urged upward by urging means of a stroke mechanism; a positioning pin disposed on an upper portion of the rod; a lower electrode into which the positioning pin can be inserted in a projectable manner; and a sensor for detecting a stroke position of the rod, wherein the urging means includes a spring for urging the rod upward, and pressurized air for assisting an urging force of the spring to urge the rod upward through a pressure receiving portion of the rod, a spring receiving seat for supporting one end side of the spring is provided on the spring, the pressurized air can at least prevent foreign matter from entering the electrode holder tube and assist the urging force of the spring, and the rod is divided into two portions via the spring receiving seat, of which an upper rod is simply placed on the spring receiving seat.

The stroke mechanism includes the urging means for urging the rod and the positioning pin upward, and an upper electrode for pressing the positioning pin downward from above with a larger force than the urging force of the urging means. The upper electrode is lowered onto a workpiece that is placed on the lower electrode. The positioning pin is thereby pressed, and the positioning pin and the rod are lowered by a predetermined stroke. An electric current is passed through the electrodes to perform welding. After that, the upper electrode is raised, and the positioning pin and the rod are thereby raised to restore their original state by the spring force or the like. A welding cycle is repeated in such a manner. The rod and the positioning pin repeat the up-and-down stroke by the stroke mechanism.

Since the urging means employs not only the spring force but also an air pressure applied to the pressure receiving portion of the rod as assistance, the durability of the spring can be improved. The pressure receiving portion of the rod is a portion where the air pressure can be applied upward to the rod.

The pressurized air can at least prevent foreign matter from entering the electrode holder tube and assist the urging force of the spring. If needed, the pressurized air can also have a cooling function to cool down the vicinity of the lower electrode. Since the single structural portion is allowed to exert the multiple functions as described above, the device can be simplified.

A lower surface of a spring receiving seat that supports one end side of the spring, or a lower surface of the positioning pin can define the pressure receiving portion.

The diameter of the lower surface of the spring receiving seat or the diameter of the lower surface of the positioning pin is made larger than the diameter of the rod. When the lower surface of the positioning pin is employed as the pressure receiving portion, the positioning pin and the rod are combined by a screw or the like. As the diameter is larger, a pressure receiving area is increased, so that a larger effect of assisting the spring force can be obtained.

Also, the rod is divided into two portions via the spring receiving seat, and the upper rod is simply placed on the spring receiving seat. Thus, even when an upper end portion of the rod around the positioning pin is worn out, for example, only the upper rod that is one of the two divided portions can be replaced, and it is not necessary to replace the lower rod. The replacing operation or the like is thereby facilitated.

In the present invention, an insulating material is interposed in each of the rod and the electrode holder tube to prevent an electric current from flowing through the rod and the electrode holder tube.

If the insulating material is not disposed in the rod and the electrode holder tube, an electric current freely flows through the rod and the electrode holder tube at the time of welding. Metal is thereby magnetized and easily attracts dust or the like. Accordingly, malfunction is caused.

In the present invention, the sensor is disposed below the rod, and the rod is directly connected to a detector of the sensor.

Any type of sensor may be employed as the above sensor. Also, any method may be employed to directly connect the rod and the detector. By directly connecting the rod and the detector, the device can be simplified. Moreover, by disposing the sensor below the rod, the device can be made compact without increasing in horizontal length, so that the device has a simplified structure.

For example, when a magnetic sensor for detecting a change in magnetic value when the detector slides along a magnetic body is used, the rod is prevented from rotating around the axis when directly connected to the detector by imparting rigidity to the detector of the magnetic sensor, a sliding portion thereof, or the like. Accordingly, the configuration is further preferably simplified.

In the present invention, a stopper for restricting a rise position of the rod is provided in a portion of the rod above the detector of the sensor, a groove for accumulating water, oil or the like is provided in an upper surface portion of the stopper, and discharging means for discharging water, oil or the like is connected to the groove.

The stopper for restricting the rise position of the rod is provided because when a screw is loosened to remove the lower electrode that is screwed onto the electrode holder tube at the time of replacing the lower electrode or the rod, for example, the rod or the lower electrode may jump out upward due to the spring force. By restricting the rise position of the rod by the stopper, the operability is improved. When the sensor is disposed below the rod, the device is made compact. However, the sensor functions are affected if oil, water, foreign matter or the like falls down along the rod. To solve the problem, the stopper is provided in the portion of the rod above the sensor, and the groove capable of accumulating water, oil or the like is provided in the upper surface of the stopper, so that the adverse effect on the sensor is avoided.

Since not only the spring force but also the pressurized air for preventing foreign matter or the like from entering the electrode holder tube is used as the urging means for urging the rod upward, the durability of the spring can be improved. Accordingly, the spring has an extended operating life, and the device configuration can be simplified. Since the rod is divided into the two portions via the spring receiving seat and the upper rod is simply placed on the spring receiving seat, the maintenance operation is facilitated. Also, by using the lower surface of the spring receiving seat or the lower surface of the positioning pin as the pressure receiving portion for receiving the air pressure, the configuration can be further simplified. Since the insulating material is interposed in each of the rod and the electrode holder tube, electric corrosion can be prevented. Since the sensor is disposed below the rod and the rod is directly connected to the detector of the sensor, the configuration can be further simplified. Furthermore, since the stopper is provided in the rod portion above the sensor and the groove capable of receiving and accumulating water, oil or the like is provided in the upper surface of the stopper, the adverse effect on the sensor can be avoided.

### BRIEF DESCRIPTION OF THE DRAWINGS

FIG. 1 is an entire view of a welding lower electrode device according to the present invention; and

FIG. 2 is an explanatory view illustrating the position of a positioning pin at the time of welding.

### DETAILED DESCRIPTION OF THE PREFERRED EMBODIMENT(S)

An embodiment according to the present invention will be described based on the accompanying drawings.

A welding lower electrode device according to the present invention can accurately determine a failure or the like in welding while reducing the size of the entire device by simplifying the device configuration. In the welding lower electrode device, a spring is disposed as urging means of a stroke mechanism of a rod instead of a component such as an air cylinder unit, and an air pressure for preventing foreign matter from entering an electrode holder tube is used to assist a spring force.

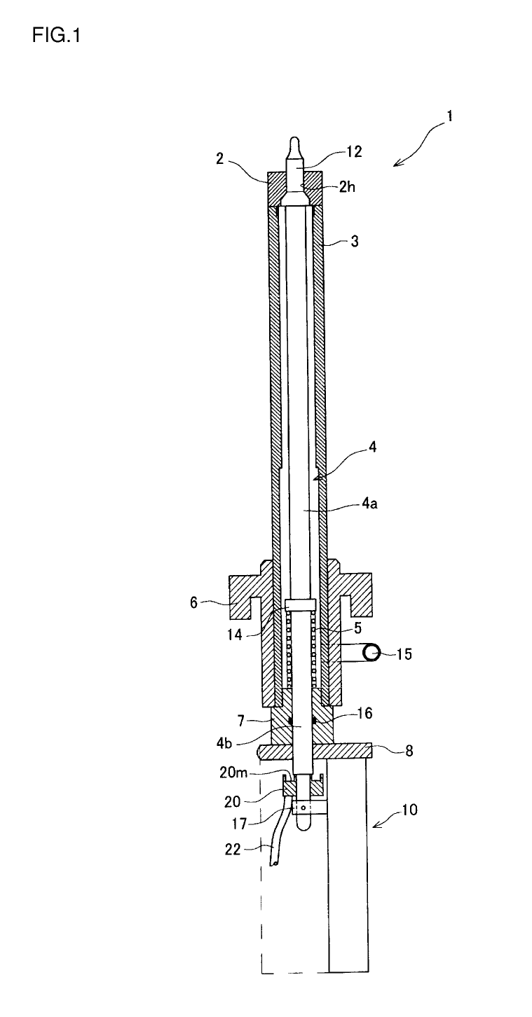

To be more specific, a welding lower electrode device 1 according to the present invention includes an electrode holder tube 3 onto which a lower electrode 2 is screwed, a rod 4 that is vertically movable within the electrode holder tube 3, and a spring 5 for urging the rod 4 upward as shown in FIG. 1. A water supply and discharge unit 6 for supplying cooling water to an unillustrated cooling water passage that is formed inside the electrode holder tube 3 is disposed in a lower end portion of the electrode holder tube 3. An insulating adapter 7 formed of an electric insulating material is disposed below the water supply and discharge unit 6. A magnetic sensor 10 for detecting the stroke position of the rod 4 is disposed below the insulating adapter 7 via a plate member 8.

A positioning pin 12 is disposed on an upper end portion of the rod 4. The positioning pin 12 is made upwardly projectable through a tapered insertion hole 2h formed in the lower electrode 2. Although the positioning pin 12 is simply placed on the upper end portion of the rod 4 in the present embodiment, the positioning pin 12 may be also fixed to the upper end portion of the rod 4 using a screw or the like.

In the present embodiment, the rod 4 is divided into an upper first rod 4a and a lower second rod 4b at the position of a spring receiving seat 14 that is formed of an electric insulating material in an intermediate portion. Also, in the present embodiment, the spring receiving seat 14 is fixed to the lower second rod 4b by any means, and the upper first rod 4a is simply placed on the spring receiving seat 14. Of course, the first rod 4a and the second rod 4b may be combined by a screw or the like.

In the present embodiment, the spring receiving seat 14 disposed in the intermediate portion of the rod 4 is employed as an insulating material on the rod 4 side, and the insulating adapter 7 disposed in the lower end portion of the electrode holder tube 3 is employed as an insulating material on the electrode holder tube 3 side.

The spring 5 is disposed in a compressed state between the spring receiving seat 14 and the insulating adapter 7. The diameter of the spring receiving seat 14 is made larger than the diameter of the rod 4. Accordingly, the lower surface of the spring receiving seat 14 becomes a pressure receiving portion for receiving pressurized air when the pressurized air is supplied into the electrode holder tube 3 as described below.

A pressurized air supply pipe 15 that opens in the vicinity of the intermediate portion of the spring 5 inside the electrode holder tube 3 is connected to the side surface of the water supply and discharge unit 6, so that the pressurized air supplied from the pressurized air supply pipe 15 can be fed into the electrode holder tube 3, and the pressure of the pressurized air can be applied upward to the lower surface of the spring receiving seat 14.

An O-ring 16 is also disposed on a sliding surface portion of the insulating adapter 7 with the second rod 4a, to thereby prevent water, oil and foreign matter such as sputter from falling down the upper first and second rods 4a and 4b.

Next, a structure around the magnetic sensor 10 will be described in detail.

The magnetic sensor 10 obtains a slide position by measuring a change in magnetic value depending on the slide position of a detector 17 when the detector 17 slides vertically on a slide groove, for example. A lower end portion of the second rod 4b is directly connected to the detector 17 through any fastening structure.

In the present embodiment, rigidity is imparted to the detector 17 or a portion around the slide groove on which the detector 17 slides, and a coupling structure by which the second rod 4b is difficult to rotate around the axis is employed to couple the detector 17 and the second rod 4b. Accordingly, the second rod 4b is prevented from rotating around the axis.

A stopper 20 for restricting the rise position of the second rod 4b is provided in a portion of the second rod 4b above a portion where the detector 17 is coupled. The stopper 20 is provided because if the stopper 20 is not provided, the lower electrode 2, the positioning pin 12 and the like suddenly jump out during operation due to the force of the spring 5 when the screw is loosened to detach the lower electrode 2 that is screwed onto the upper end portion of the electrode holder tube 3 at the time of replacing the lower electrode 2 or the first rod 4a, for example, and it is not preferable from the viewpoint of operability. When the stopper 20 is provided, the restoration of the spring 5 is restricted to a stroke from the original position of the stopper 20 to a position where the stopper 20 collides with the lower surface of the plate 8, so that a repulsive force can be weakened.

Meanwhile, a groove 20m capable of receiving and accumulating water, oil and foreign matter such as sputter that fall down the second rod 4b from above is provided in the upper surface of the stopper 20, and a discharge pipe 22 as discharging means capable of discharging water, oil or the like in the groove 20m is connected to the groove 20m.

Such water, oil and foreign matter such as sputter are normally prevented from falling down by the O-ring 16 or the like of the insulating adapter 7. However, the O-ring 16 or the sliding surface of the insulating adapter 7 with the rod may be worn out when repeatedly used. The groove 20m and the discharge pipe 22 are effectively used in such a case. If water, foreign matter or the like enter the portion where the detector 17 of the magnetic sensor 10 slides, the sensor cannot exert normal functions. It is thus particularly necessary to prevent foreign matter from entering the portion of the magnetic sensor 10.

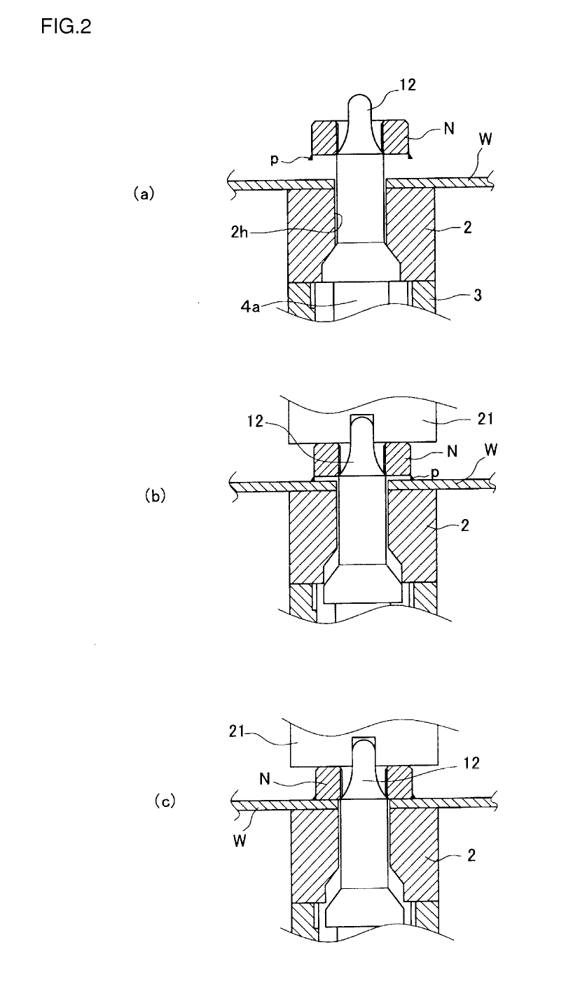

The operation or the like of the device as described above will be described based on FIG. 2.

The positioning pin 12 normally projects upward through the insertion hole 2h of the lower electrode 2 due to the repulsive force of the spring 5 and the assistance of the pressurized air. A plate-like workpiece W such as a steel plate in which a pilot hole for insertion of a bolt is formed is placed on the lower electrode 2 so as to be fitted onto the positioning pin 12 from above, and a nut N is placed over the positioning pin 12 onto the plate-like workpiece W as shown in FIG. 2(A).

When the nut N assumes a normal posture, a projection portion p (a portion melted by welding) is located at a lower position, so that a gap is formed between the projection portion p and the plate-like workpiece W.

Subsequently, as shown in FIG. 2(B), an upper electrode 21 is lowered from above and presses the upper surface of the nut N downward to thereby press the nut N against the plate-like workpiece W. Since the force urging the positioning pin 12 upward by the spring 5 and the air pressure is smaller than the pressing force of the upper electrode 21 to press the nut N downward, the nut N is pressed and thus lowered with the positioning pin 12 and the rod 4, so that the projection portion p of the nut N abuts against the plate-like workpiece W as shown in FIG. 2(B). At this point, a bevel portion of the positioning pin 12 is separated from a tapered portion of the tapered insertion hole 2h of the lower electrode 2. Thus, a gap is formed between the insertion hole 2h and the positioning pin 12. Accordingly, the pressurized air supplied into the electrode holder tube 3 flows upward, and is then blown out upward through the gap of the tapered insertion hole 2h, to thereby cool the vicinity of the lower electrode 2.

The position of the positioning pin 12 at this point is measured by the lower magnetic sensor 10, and is set as a reference point. An electric current is passed through the upper electrode 21 and the lower electrode 2, and the projection portion p is thereby melted to weld the nut N and the plate-like workpiece W as shown in FIG. 2(C). Even if sputter or the like is generated, the foreign matter is prevented from entering the electrode holder tube 3 since the pressurized air is blown out through the gap of the tapered insertion hole 2h of the lower electrode 2.

When the welding is completed, the pressurization by the upper electrode 21 is stopped, and the upper electrode 21 is raised. The second rod 4b and the first rod 4a rise with the positioning pin 12 due to the repulsive force of the spring 5 and the upward urging force of the pressurized air against the pressure receiving portion (the lower surface of the spring receiving seat 14). The bevel portion of the positioning pin 12 comes into contact with the tapered portion of the tapered insertion hole 2h of the lower electrode 2, so that an upper end portion of the positioning pin 12 projects upward from the lower electrode 2. In other words, the rod 4 moves up and down as one stroke during one cycle of welding.

The welding cycle as described above is repeated many times. Since the upward urging means of the stroke mechanism including the upper electrode 21 and the urging force of the spring 5 or the like includes not only the repulsive force of the spring 5 but also the assistance of the pressurized air against the pressure receiving portion (the lower surface of the spring receiving seat 14), the durability of the spring 5 can be improved. For example, when the upper electrode 21 is removed so as to be replaced, cooling water on the upper electrode 21 side drops from above to enter the electrode holder tube 3 through the insertion hole 2h of the lower electrode 2. However, the positioning pin 12 is pressed upward to reliably seal the tapered insertion hole 2h, so that water is more reliably prevented from entering the electrode holder tube 3. Also, since the entire device is made compact, the device can be installed at any place.

Since the spring receiving seat 14 is used as the pressure receiving portion of the pressurized air that assists the spring 5, both the spring receiving function and the pressure receiving function are achieved, so that the device is effectively simplified.

A contact portion between the upper end portion of the first rod 4a and the positioning pin 12 is particularly easy to wear out. Even when the portion is worn out, only the replaceable first rod 4a can be conveniently replaced.

Since the intermediate portion of the rod 4 is insulated by the spring receiving seat 14 as the insulating material and the lower end portion of the electrode holder tube 3 is insulated by the insulating adapter 7 as the insulating material, an electric current from the rod 4 to the electrode holder tube 3 or from the electrode holder tube 3 to the rod 4 is blocked, and the device is thus difficult to magnetize.

Since the lower end portion of the second rod 4b is directly connected to the detector 17 and the coupling structure by which the rod is difficult to rotate around the axis is employed to connect the lower end portion of the second rod 4b to the magnetic sensor 10, the device is further simplified.

Only the lower surface of the spring receiving seat 14 is employed as the pressure receiving portion in the aforementioned embodiment. However, for example, when the positioning pin 12 is fixed to the first rod 4a by a screw or the like, the lower surface of the positioning pin 12 may be also employed as the pressure receiving portion by making the diameter of the lower surface of the positioning pin 12 to be larger than the diameter of the first rod 4a. In this case, both the lower surface of the positioning pin 12 and the lower surface of the spring receiving seat 14 function as the pressure receiving portion.

Note that the present invention is not limited to the aforementioned embodiment, and those having substantially the same configuration as the matter set forth in the claims of the present invention and producing the same effect fall within the technical scope of the present invention.

For example, the sensor for detecting a stroke may be any sensor that is analog or digital, and not only the magnetic sensor, but also a light sensor, a laser sensor, a resistive sensor, a pulse sensor, a plasma sensor, a photoelectric sensor, a coil sensor or the like may be employed.

Since the welding lower electrode device according to the present invention can accurately measure the stroke position of the rod with a simple configuration, the device is expected to be widely used in future nut and bolt welding machines or the like.

What is claimed is:

1. A welding lower electrode device comprising: a rod disposed within an electrode holder tube and urged upward by urging means of a stroke mechanism; a positioning pin disposed on an upper portion of the rod; a lower electrode into which the positioning pin can be inserted in a projectable manner; and a sensor for detecting a stroke position of the rod, wherein the urging means comprises a spring for urging the rod upward, and pressurized air for assisting an urging force of the spring to urge the rod upward through a pressure receiving portion of the rod, a spring receiving seat for supporting one end side of the spring is provided on the spring, the pressurized air can at least prevent foreign matter from entering the electrode holder tube and assist the urging force of the spring, and the rod is divided into two portions via the spring receiving seat, of which an upper rod is simply placed on the spring receiving seat.

2. The welding lower electrode device according to claim 1, wherein a lower surface of the spring receiving seat or a lower surface of the positioning pin defines the pressure receiving portion.

3. The welding lower electrode device according to claim 1, wherein an insulating material is interposed in each of the rod and the electrode holder tube to prevent an electric current from flowing through the rod and the electrode holder tube.

4. The welding lower electrode device according to any one of claims 1, wherein the sensor is disposed below the rod, and the rod is directly connected to a detector of the sensor.

5. The welding lower electrode device according to claim 4, wherein a stopper for restricting a rise position of the rod is provided in a portion of the rod above the detector of the sensor, a groove for accumulating water, oil or the like is provided in an upper surface portion of the stopper, and discharging means for discharging water, oil or the like is connected to the groove.

6. The welding lower electrode device according to claim 2, wherein an insulating material is interposed in each of the rod and the electrode holder tube to prevent an electric current from flowing through the rod and the electrode holder tube.

7. The welding lower electrode device according to any one of claims 2, wherein the sensor is disposed below the rod, and the rod is directly connected to a detector of the sensor.

8. The welding lower electrode device according to any one of claims 3, wherein the sensor is disposed below the rod, and the rod is directly connected to a detector of the sensor.

9. The welding lower electrode device according to any one of claims 6, wherein the sensor is disposed below the rod, and the rod is directly connected to a detector of the sensor.

10. The welding lower electrode device according to claim 7, wherein a stopper for restricting a rise position of the rod is provided in a portion of the rod above the detector of the sensor, a groove for accumulating water, oil or the like is provided in an upper surface portion of the stopper, and discharging means for discharging water, oil or the like is connected to the groove.

11. The welding lower electrode device according to claim 8, wherein a stopper for restricting a rise position of the rod is provided in a portion of the rod above the detector of the sensor, a groove for accumulating water, oil or the like is provided in an upper surface portion of the stopper, and discharging means for discharging water, oil or the like is connected to the groove.

12. The welding lower electrode device according to claim 9, wherein a stopper for restricting a rise position of the rod is provided in a portion of the rod above the detector of the sensor, a groove for accumulating water, oil or the like is provided in an upper surface portion of the stopper, and discharging means for discharging water, oil or the like is connected to the groove.
